(19) United States
(12) Patent Application Publication
(10) Pub. No.: US 2025/0015578 A1
(43) Pub. Date: Jan. 9, 2025

(54) ELECTRICAL JUNCTION BOX

(71) Applicant: SUMITOMO WIRING SYSTEMS, LTD., Mie (JP)

(72) Inventor: Shunsuke KATSUSE, Mie (JP)

(21) Appl. No.: 18/285,597

(22) PCT Filed: Mar. 17, 2022
(86) PCT No.: PCT/JP2022/012350

§ 371 Date: Oct. 4, 2023

(30) Foreign Application Priority Data
Apr. 9, 2021 (JP) 2021-066185

(51) Int. Cl. H02G 3/16; H02G 3/08

(52) U.S. Cl. CPC H02G 3/16; H02G 3/083

(57) ABSTRACT

One object is to hold a stably attached state. An electrical junction box (A) includes: a base member (10) having a component housing chamber (12) with open lateral surfaces; and side-wall members (11) that are separate members from the base member (10) and are attached to the base member (10) so as to cover the lateral surfaces of the component housing chamber (12). The side-wall members (11) are provided with front insertion portions (15) and rear insertion portions (16), and the base member (10) is provided with front fitting portions (13) and rear fitting portions (14) into which the front insertion portions (15) and the rear insertion portions (16) are slid and inserted in a process of attaching the side-wall members (11) to the base member (10).

### TECHNICAL FIELD

The present disclosure relates to an electrical junction box.

### BACKGROUND

Patent Document 1 discloses a technique for installing a blocking element in a blocking element housing formed in a junction box body. The blocking element housing has a space that is open to the upper surface of the junction box body, and the blocking element is fitted into the blocking element housing from above the junction box body.

### PRIOR ART DOCUMENT

### Patent Document

Patent Document 1: JP 2021-002441 A

### SUMMARY OF THE INVENTION

### Problems to be Solved

In the above structure, the peripheral wall of the blocking element housing protects the blocking element by surrounding the blocking element from the front, rear, left, and right. Therefore, when an operator installs the blocking element to the blocking element housing by picking the blocking element up with the operator's fingers, the fingers picking the blocking element may interfere with the peripheral wall. To avoid such a situation, it is conceivable to mold side-walls of the junction box body covering a lateral surface of the blocking element housing as separate parts. Such a configuration allows the operator to house the blocking element in the blocking element housing without the operator's finger interfering with the side-wall members. It is possible to protect the blocking element by housing the blocking element in the blocking element housing, and thereafter attaching the side-wall members to a base member.

As a structure for holding a side-wall member and the base member in an attached state, it is conceivable of a structure for elastically engaging an elastic locking piece formed on one of the side-wall member and the base member against a locking portion formed on the other. However, with a structure for elastically locking the elastic locking piece, there is a risk that the side-wall member and the base member may become unstable relative to each other.

The electrical junction box according to the present disclosure has been completed considering the above circumstances and aims to maintain a stable assembly state.

### Means to Solve the Problem

An electrical junction box according to the present disclosure includes:
a base member having a component housing chamber with open lateral surfaces; and
side-wall members that are separate members from the base member and are attached to the base member so as to cover the lateral surfaces of the component housing chamber,
wherein the side-wall members are provided with insertion portions, and
the base member is provided with fitting portions into which the insertion portions are slid and inserted in a process of attaching the side-wall members to the base member.

### Effect of the Invention

The present disclosure makes it possible to maintain a stable assembly state.

### BRIEF DESCRIPTION OF THE DRAWINGS

FIG. 1 is a perspective view of an electrical junction box according to a first embodiment seen from a forward and oblique upward direction.

FIG. 2 is a perspective view of the electrical junction box from a rearward and oblique upward direction.

FIG. 3 is a perspective view of a base member seen from a forward and oblique upward direction.

FIG. 4 is a perspective view of the base member seen from a rearward and oblique upward direction.

FIG. 5 is a perspective view of a side-wall member seen from a forward and oblique upward direction.

FIG. 6 is a perspective view of the side-wall member seen from a rearward and oblique upward direction.

FIG. 7 is a perspective view showing the side-wall member separated into the side-wall body and a bus bar.

FIG. 8 is a front cross-sectional view showing a state in which front insertion portions are fitted into front fitting portions.

FIG. 9 is a planar cross-sectional view showing a state in which the front insertion portions are fitted into groove portions in the front fitting portions.

FIG. 10 is a planar cross-sectional view showing a state in which fitting protrusions of the front insertion portions are fitted into fitting recess portions of the front fitting portions.

FIG. 11 is a front cross-sectional view showing a state in which overhanging portions restrict the side-wall member from expanding.

FIG. 12 is a bottom view of the electrical junction box.

FIG. 13 is a plan view showing a state in which the base member and a pair of side-wall members are separated.

### DETAILED DESCRIPTION TO EXECUTE THE INVENTION

### Description of Embodiments of Present Disclosure

First, embodiments of the present disclosure will be listed and described.

(1) An electrical junction box according to the present disclosure includes: a base member having a component housing chamber with open lateral surfaces; and side-wall members that are separate members from the base member and are attached to the base member so as to cover the lateral surfaces of the component housing chamber, wherein the side-wall members are provided with insertion portions, and the base member is provided with fitting portions into which the insertion portions are slid and inserted in a process of attaching the side-wall members to the base member. With the configuration according to the present disclosure, the side-wall members are slid and fitted to the base member. Therefore, compared to when an elastic locking structure is used, the side-wall members and the base member can be held in a more stably attached state.

(2) It is preferable that the base member is provided with guiding portions that guide the insertion portions to the fitting portions. With this configuration, the insertion portions can be guided by the guiding portions, and therefore workability is high during the attachment of the side-wall members to the base member.

(3) It is preferable that the fitting portions respectively have groove portions that allow the insertion portions to slide in a state of being housed therein, and the fitting portions are respectively provided with windows that connect the groove portions to an outside of the fitting portions. With this configuration, the operator can visually check the fitting state of the insertion portions in the groove portions by looking into the windows.

(4) In (3), it is preferable that the windows are respectively located at distal ends of the groove portions in a fitting direction of the insertion portions. With this configuration, whether or not the insertion portions have reached the distal ends of the groove portions can be checked.

(5) It is preferable that the base member has connection members respectively provided with plate-shaped mounting portions, the side-wall members respectively have busbars provided with connection plate portions, and the connection plate portions overlap the plate-shaped mounting portions in a same direction as a direction in which the side-wall members are attached to the base member. With this configuration, it is possible to connect the plate-shaped mounting portions and the connection plate portions to each other by attaching the side-wall members to the base member.

(6) In (5), it is preferable that the connection plate portions are located near the insertion portions. With this configuration, it is possible to accurately attach the connection plate portions to the plate-shaped mounting portions by fitting the insertion portions into the fitting portions.

(7) In (5) or (6), it is preferable that the fitting portions and the plate-shaped mounting portions are located at a front end of the base member, the plate-shaped mounting portions and the connection plate portions are fixed by fastening members, and elastic locking portions that hold the side-wall members in an attached state by elastically locking with the side-wall members are provided at a rear end of the base member. With this configuration, the side-wall members are each held by the base member at two positions on the front and rear ends of the base member, and therefore the attached state of the base member and the side-wall members is stable. Fastening work with the bolts and the nuts need only be performed at the front end of the base member, and therefore workability is higher than when fastening work with the fastening members is performed at both front and rear ends.

### DETAILS OF EMBODIMENTS OF PRESENT DISCLOSURE

### First Embodiment

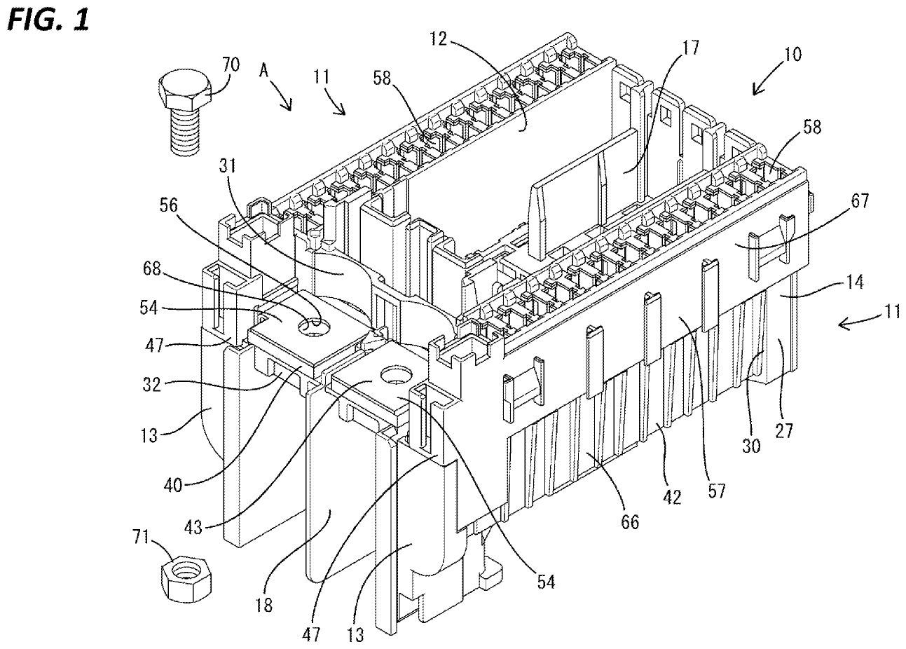

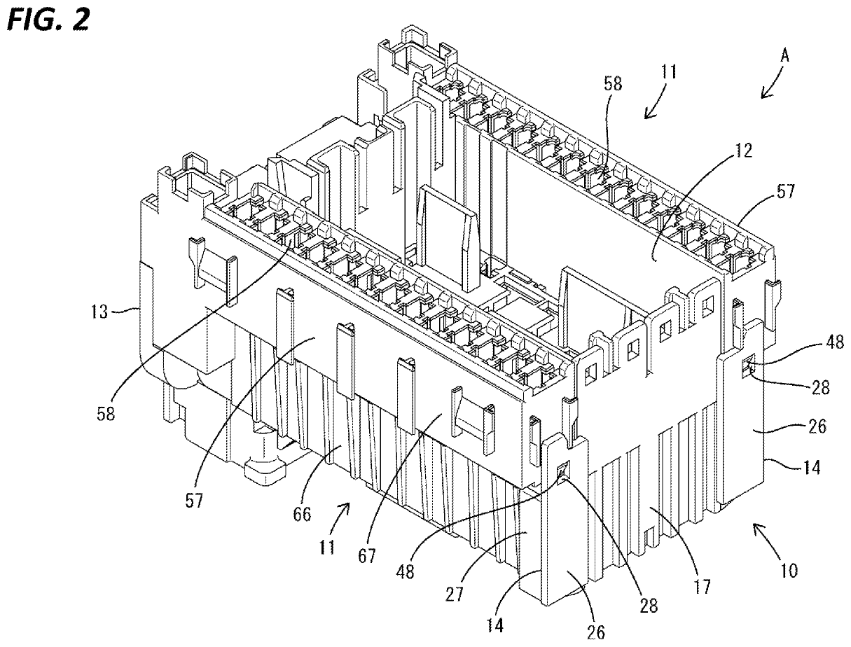

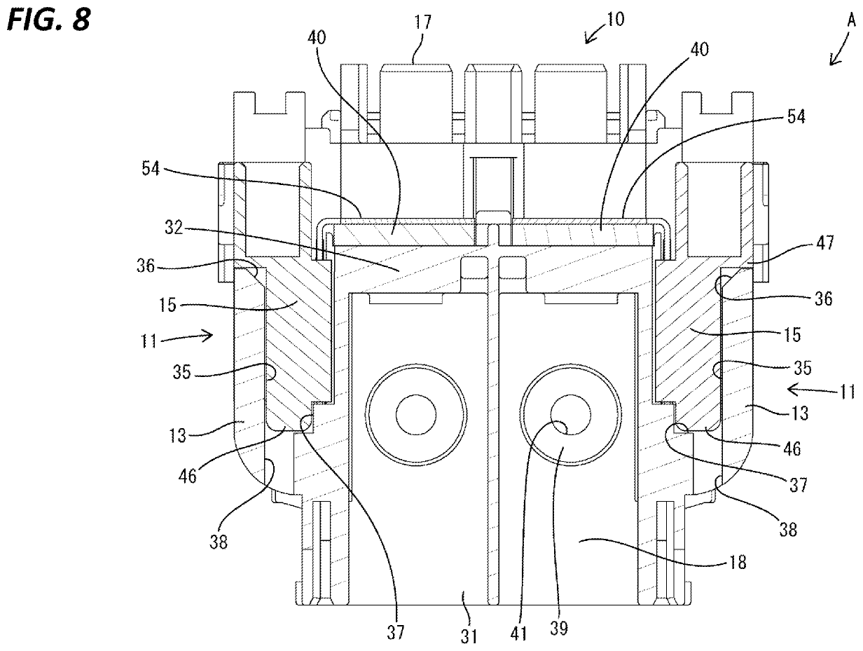

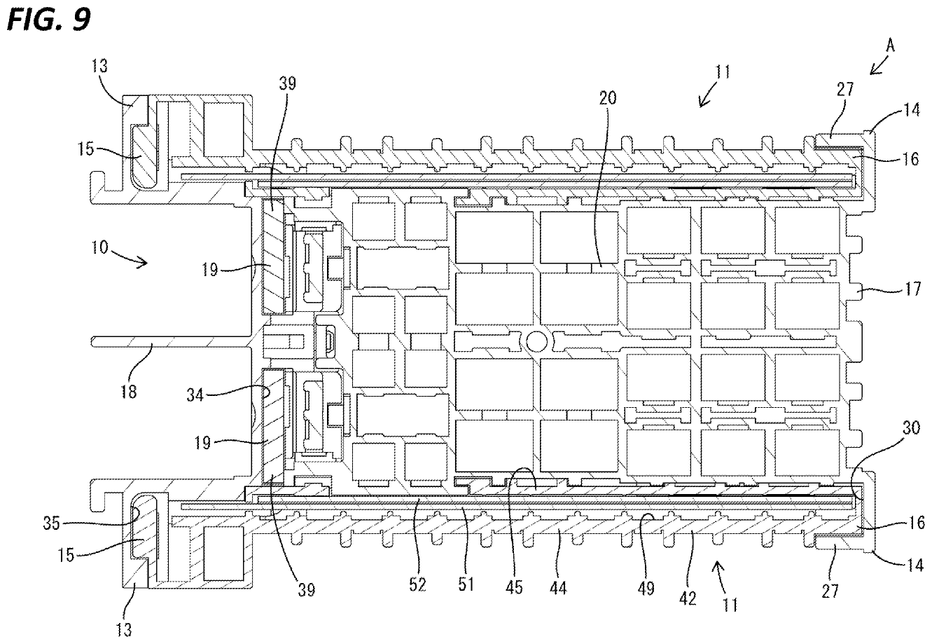

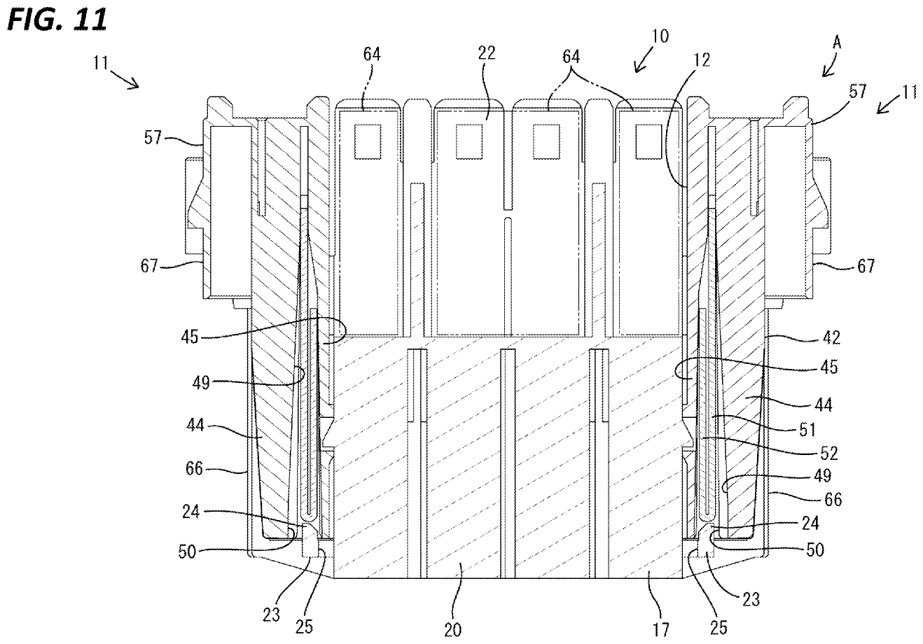

A first embodiment embodying an electrical junction box according to the present disclosure will be described with reference to FIGS. 1 to 13. Note that the present invention is not limited to these examples. The present invention is indicated by the claims, and is intended to include all modifications made within the meaning and scope of equivalents of the claims. In the first embodiment, regarding forward and rearward directions with respect to an electrical junction box A, the downward and oblique leftward direction in FIGS. 1, 3, 5, and 7, the upward and oblique leftward direction in FIGS. 2, 4, and 6, and the direction to the left in FIGS. 9, 10, 12, and 13 are defined as forward directions. Regarding upward and downward directions, the directions shown in FIGS. 1 to 8 and 11 are defined as upward and downward directions. Regarding directions to the left and right, the directions shown in FIGS. 8 and 11 and defined as the direction to the left and the direction to the right.

### Overview of Electrical Junction Box A

As shown in FIGS. 1 and 2, an electrical junction box A according to the first embodiment includes a base member 10 and a symmetrical pair of left and right side-wall members 11 that are separate members from the base member 10. The pair of side-wall members 11 are attached to the base member 10 so as to sandwich the base member 10 from the left and right. The electrical junction box A has a component housing chamber 12 divided by the base member 10 and the pair of side-wall members 11. The component compartment 12 is open to the upper surface of the electrical junction box A. As shown in FIG. 11, the component compartment 12 is configured to house a plurality of electrical components 64 such as a fusible link.

A pair of left and right front fitting portions 13 are formed in a front end portion of the base member 10, and a pair of left and right rear fitting portions 14 are formed at the rear end of the base member 10. A pair of left and right front insertion portions 15 are formed at the front ends of the side-wall members 11, and a pair of left and right rear insertion portions 16 are formed at the rear ends of the side-wall members 11. The base member 10 and the side-wall members 11 are held in an attached state by the front insertion portions 15 fitted to the front fitting portions 13 and the rear insertion portions 16 fitted to the rear fitting portions 14.

### Base Member 10

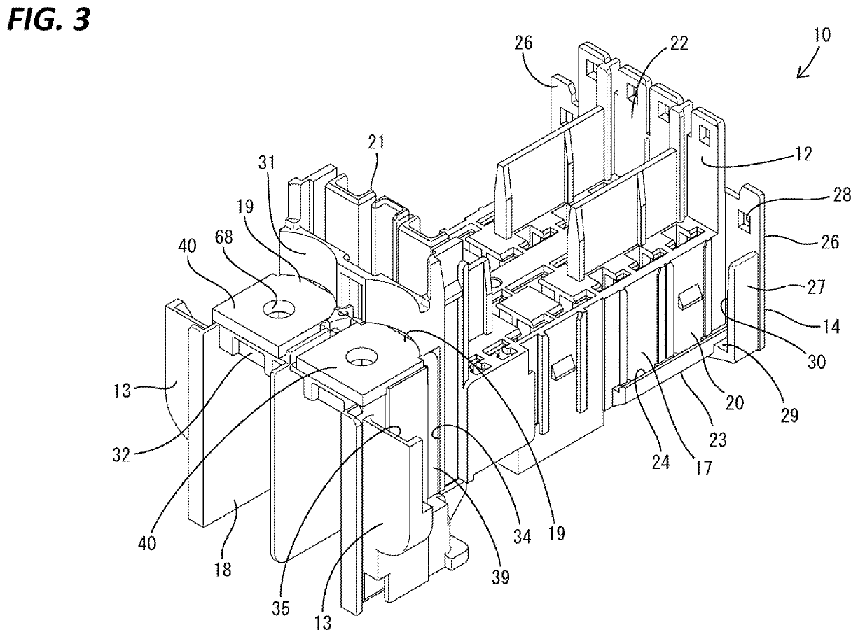

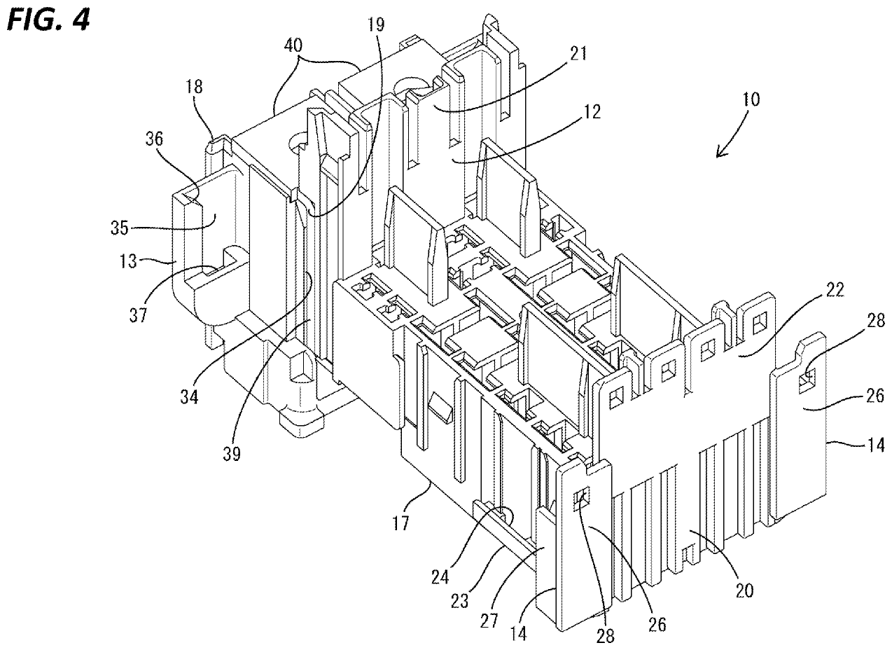

The base member 10 includes a holding member 17 made from synthetic resin, a terminal block 18 that is made from synthetic resin and that is a separate component from the holding member 17, and plates 19 that are a symmetrical pair of left and right connection members. As shown in FIGS. 3 and 4, the holding member 17 is a single component including a cuboid-shaped main body portion 20 whose long sides are oriented in the front-rear direction, a front plate portion 21 that extends upward from the front end edge of the main body portion 20, and a rear plate portion 22 that extends upward from the rear end edge of the main body portion 20. The space surrounded by the upper surface of the main body portion 20, the rear surface of the front plate portion 21, and the front surface of the rear plate portion 22 functions as the component housing chamber 12. In a state in which the side-wall members 11 are not attached to the base member 10, the component housing chamber 12 is open to the outside of the base member 10 in the upper surface of the base member 10 and the left and right lateral surfaces of the base member 10.

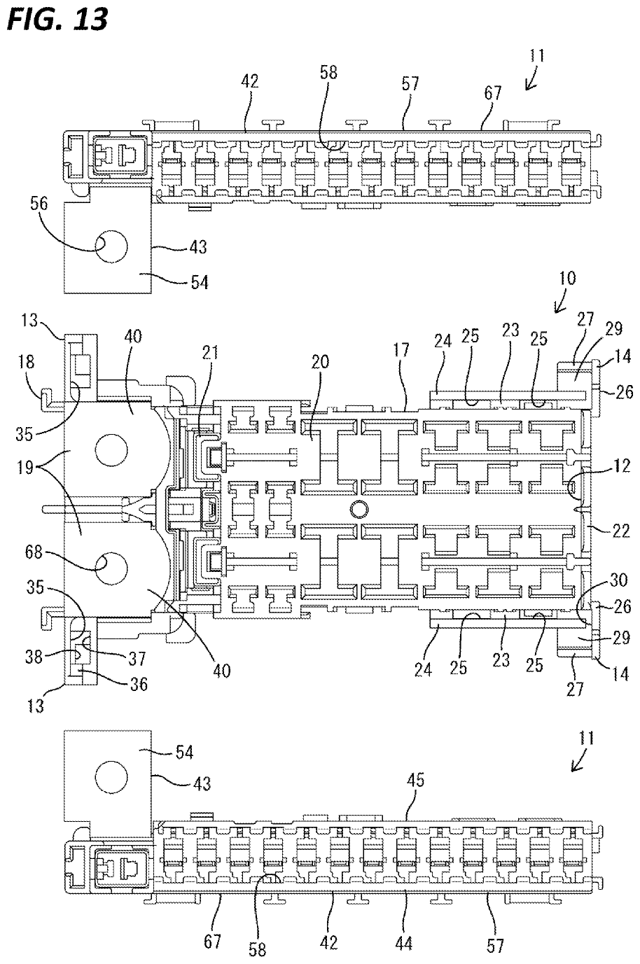

As shown in FIGS. 3, 4, and 11 to 13, a symmetrical pair of left and right overhanging portions 23 extending in a front-rear direction are formed at the rear end of the main body portion 20. The overhanging portions 23 protrude outward in the left-right direction, from the lower edge of the outer lateral surface of the main body portion 20. As shown in FIGS. 3, 4, 11, and 13, ribbed hook portions 24 protruding upward are formed on the protruding edges of the overhanging portions 23. As shown in FIGS. 11 and 13, a plurality of communication holes 25 that are arranged at intervals in the front-rear direction are provided in the overhanging portions 23 between the main body portion 20 and the hook portions 24.

A symmetrical pair of left and right rear fitting portions 14 are formed on left and right end portions of the rear plate portion 22. As shown in FIGS. 3 and 4, the rear fitting portions 14 include plate-shaped elastic locking portions 26 whose plate-thickness directions are oriented in the front-rear direction, and plate-shaped restricting portions 27 whose plate-thickness directions are oriented in the left-right direction. Locking holes 28 are formed in the rear surfaces of the elastic locking portions 26. As shown in FIG. 13, the side edge portions of the elastic locking portions 26 and the rear edge portions of the plate-shaped restricting portions 27 are continuous at right angles. The lower edge portions of the elastic locking portions 26 and the lower edge portions of the plate-shaped restricting portions 27 are continuous with the outer surface of the lower end portion of the main body portion 20 via reinforcing portions 29. The space surrounded by the main body portion 20, an elastic locking portion 26, and a plate-shaped restricting portion 27 serves as a guide groove 30 that is open forward and upward.

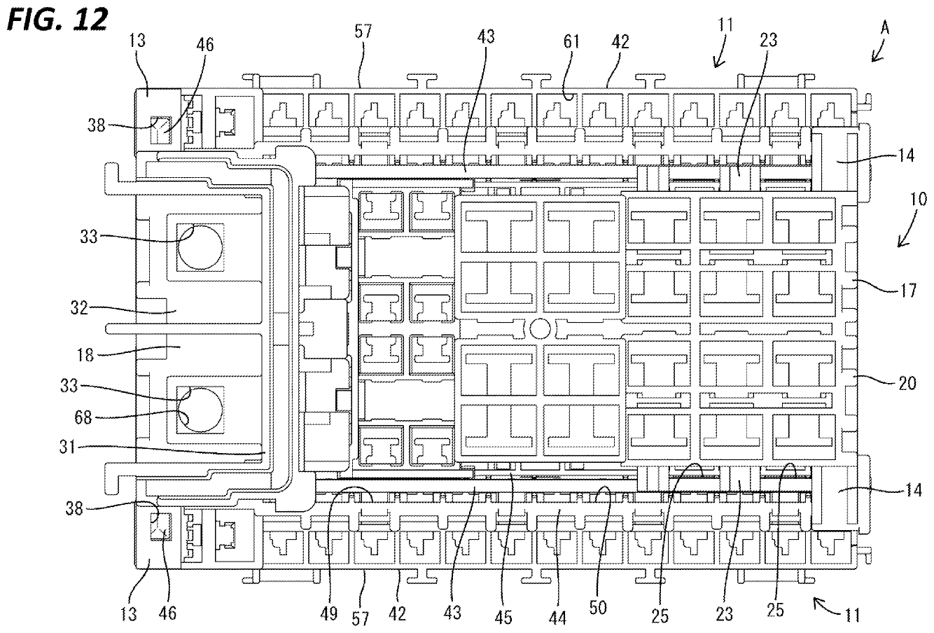

As shown in FIGS. 1, 3, 8, and 12, the terminal block 18 is a single component including supporting plate portions 31 whose plate-thickness directions are oriented in the front-rear direction, and receiving plate portions 32 whose plate-thickness directions are oriented in the top-bottom direction. As shown in FIG. 12, bolt holes 33 that pass through the receiving plate portions 32 in the top-bottom direction are formed in the receiving plate portions 32. The terminal block 18 is attached to the holding member 17 so as to cover the front surface of the front plate portion 21. As shown in FIGS. 3, 4, 9, and 10, a pair of left and right housing spaces 34 are formed between the front plate portion 21 of the holding member 17 and the supporting plate portions 31 of the terminal block 18. The upper end portions of the housing spaces 34 are open toward the front of the base member 10 in the shape of left-right-direction slits.

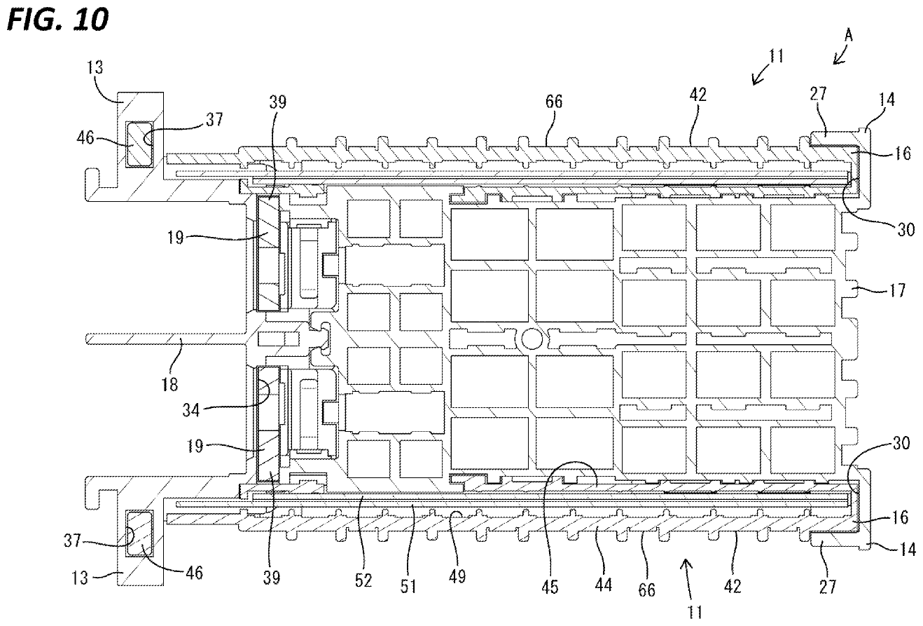

A symmetrical pair of left and right front fitting portions 13 are formed on left and right end portions of the terminal block 18. As shown in FIGS. 4, 8, 9, and 13, groove portions 35 extending in the top-bottom direction are formed in the rear surfaces of the front fitting portions 13. The upper ends of the groove portions 35 are open to the upper surface of the terminal block 18. Tapered guiding portions 36 are formed in the upper end portions of the groove portions 35. As shown in FIGS. 8 and 10, fitting recess portions 37 whose four surfaces, namely the front, rear, left, and right surfaces, are surrounded are formed in the front fitting portions 13. The upper ends of the fitting recess portions 37 are connected to the lower ends of the groove portions 35. As shown in FIGS. 8 and 12, windows 38 that allow the fitting recess portions 37 and the lower end surfaces of the front fitting portions 13 to communicate with each other in the top-bottom direction are formed at the lower ends of the front fitting portions 13.

The plates 19 are single components formed by bending an elongated, thin metal sheet material. Each plate 19 includes a plate-shaped power supply portion 39 (see FIGS. 3, 4, 9, and 10) and a plate-shaped mounting portion 40 (see FIGS. 1 to 3, 8, and 13) that are continuous with each another with a right angle therebetween. The plate-shaped power supply portion 39 has the shape of a flat plate whose plate-thickness direction is oriented in the front-rear direction. A power-supply connection hole 41 (see FIG. 8) that passes through the plate-shaped power supply portion 39 in the front-rear direction is formed in the plate-shaped power supply portion 39. The plate-shaped mounting portion 40 has the shape of a flat plate whose plate thickness direction is oriented in the top-bottom direction, and extends forward from the upper end edge of the plate-shaped power supply portion 39. As shown in FIG. 3, a mounting hole 68 that passes through the plate-shaped mounting portion 40 in the top-bottom direction is formed in the plate-shaped mounting portion 40.

The plates 19 are attached to the base member 10 in a state in which the plate-shaped power supply portions 39 thereof are housed inside the housing spaces 34, and the plate-shaped mounting portions 40 are exposed to the outside of the housing spaces 34 and are mounted on the receiving plate portions 32. The hole edge portions of the power-supply connection holes 41 in the plate-shaped power supply portions 39 are exposed to the outside from cutout portions formed in the supporting plate portions 31. Power-supply terminals (not shown) connected to a battery (not shown) are connected to the plate-shaped power supply portions 39 via the power-supply connection holes 41.

### Side-Wall Members 11

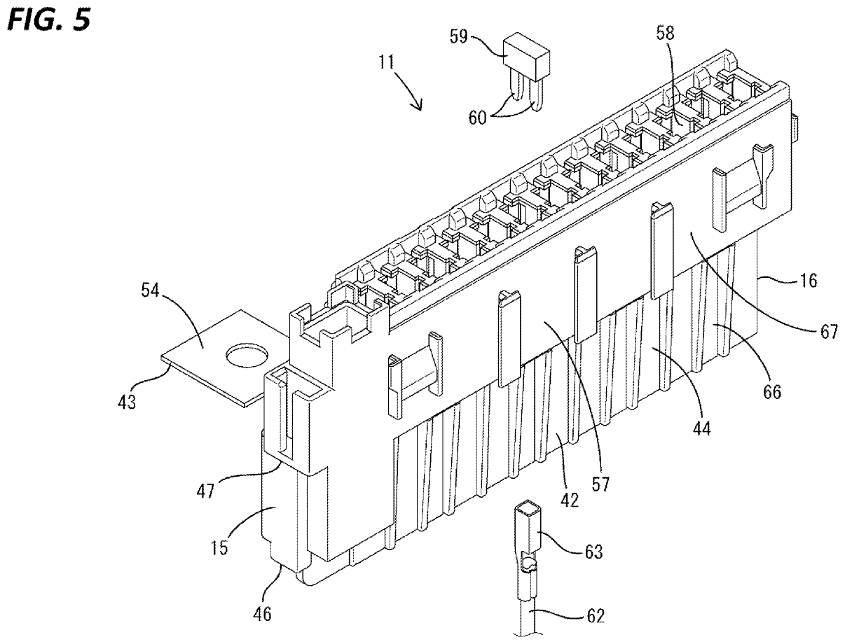

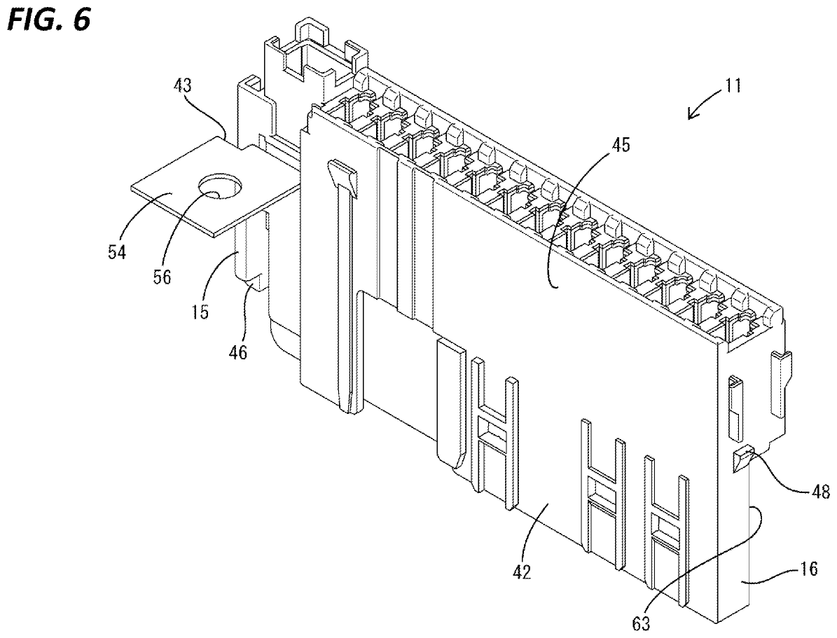

Each side-wall member 11 is formed by attaching a side-wall main body 42 made from synthetic resin and a busbar 43 made from metal to each another. As shown in FIGS. 5 to 7, the side-wall main body 42 is a single component which has a shape that is elongated in the front-rear direction in a plan view, and whose wall-thickness direction is oriented in the left-right direction. As shown in FIGS. 9 to 12, the side-wall main body 42 includes an outer wall portion 44 whose wall-thickness direction is oriented in the left-right direction, and an inner wall portion 45 whose wall-thickness direction is oriented in the left-right direction. Lower end-side portions of the front end edge portions of the side-wall main bodies 42 function as the front insertion portions 15. As shown in FIGS. 5 to 8, fitting protrusions 46 that protrude downward are formed at lower ends of the front insertion portions 15. As shown in FIGS. 1, 5, 7, and 8, stoppers 47 protruding forward and laterally in a step-like shape are formed at upper end portions of the front insertion portions 15. Lower end-side portions of the rear end edge portions of the side-wall main bodies 42 function as the rear insertion portions 16. As shown in FIGS. 2 and 6, locking protrusions 48 having a protruding shape are formed on the rear end surfaces of the side-wall main bodies 42.

As shown in FIGS. 9 to 12, one bus bar housing chamber 49 is formed in each side-wall main body 42 so as to be sandwiched between the outer wall portion 44 and the inner wall portion 45. The busbar housing chamber 49 is a narrow space that has a smaller dimension in the left-right direction than in the front-rear direction and the top-bottom direction. As shown in FIGS. 11 and 12, a busbar mounting port 50 that is open in the shape of a slit extending in the front-rear direction is formed in the lower surface of each side-wall main body 42. The busbar mounting port 50 is an opening that is used to attach the busbar 43 to the busbar housing chamber 49.

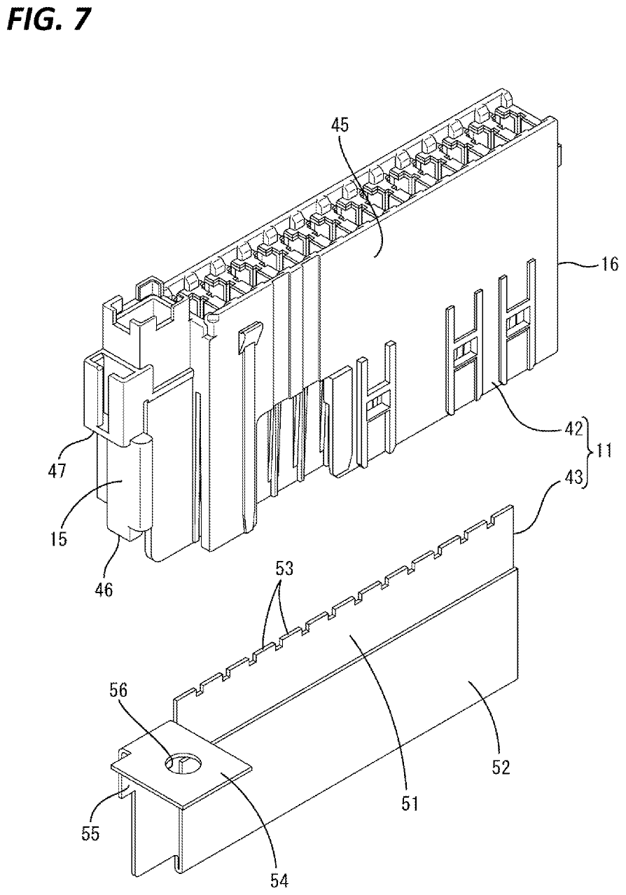

The busbar 43 is a single component that is formed by bending a flat metal plate punched out in a predetermined shape. As shown in FIG. 7, the busbar 43 includes one flat-plate-shaped substrate portion 51 whose plate-thickness direction is oriented in the left-right direction, one flat-plate-shaped heat-dissipating plate portion 52, a plurality of tabs 53, and one connection plate portion 54. In a side view in which the busbar 43 is seen from the left-right direction, the substrate portion 51 and the heat-dissipating plate portion 52 have the shape of rectangles. The heat-dissipating plate portion 52 extends from the lower edge of the substrate portion 51 so as to overlap the inner surface of the substrate portion 51. The plurality of tabs 53 protrude upward from the upper end edge of the substrate portion 51, and are arranged in the front-rear direction at intervals.

The connection plate portion 54 protrudes inward in a horizontal direction, from the upper edge of a supporting portion 55 that is continuous with the front end of the substrate portion 51. A through-hole 56 that passes through the connection plate portion 54 in the top-bottom direction is formed in the connection plate portion 54. The busbar 43 is attached to the side-wall main body 42 in a state in which the substrate portion 51, the heat-dissipating plate portion 52, and the tabs 53 are housed in the busbar housing chamber 49. The connection plate portion 54 is exposed to the outside of the side-wall main body 42, and projects further inward than the side-wall main body 42 in the left-right direction, or in other words, toward the base member 10-side.

As shown in FIGS. 1, 2, 5, 12, and 13, a wide enlarged-width portion 57 is formed in an upper end portion of the side-wall main body 42. In the enlarged-width portion 57, a plurality of fuse housing chambers 58 open in the upper surface of the side-wall main body 42 are arranged in a single line in the front-rear direction. The lower ends of the plurality of fuse housing chambers 58 are connected to the busbar housing chamber 49. Fuses 59 (see FIG. 5) are attached to the fuse housing chambers 58 from above the side-wall member 11. One lead 60 of the leads 60 of each fuse 59 is connected to a tab 53 of the busbar 43. In the lower-end-side region of the enlarged-width portion 57, the plurality of cavities 61 open in the lower surface of the side-wall main body 42 are arranged in a single line in the front-rear direction (see FIG. 12). The upper ends of the plurality of cavities 61 are individually in communication with the lower ends of the plurality of fuse housing chambers 58. Inside the cavities 61, harness terminals 63 that are individually connected to a plurality of electric wires 62 forming a wire harness are housed. The harness terminals 63 are connected to the other leads 60 of the fuses 59.

### Assembly Procedure of Electrical Junction Box A

When the electrical junction box A is to be assembled, the holding member 17 and the terminal block 18 are separated from each other. In this state, the terminal block 18 is made to temporarily hold the plates 19 in a state in which the plate-shaped mounting portions 40 are mounted on the receiving plate portions 32 and the plate-shaped power supply portions 39 are placed on the rear surface of the terminal block 18. Next, the terminal block 18 and the plates 19 are attached to the holding member 17 by being pressed into the holding member 17 from below. By attaching the terminal block 18 to the holding member 17, the housing spaces 34 are formed and the plate-shaped power supply portions 39 of the plates 19 are housed inside the housing spaces 34, and the assembly of the base member 10 is complete.

After assembling the base member 10, the electric components 64 are attached to the holding member 17 from above the base member 10 such that the electric components 64 are housed inside the component housing chamber 12. The component housing chamber 12 is open to the left and right sides of the base member 10. Thus, the fingers of the operator pinching the electric components 64 do not interfere with the base member 10 if the operator pinches the electric components 64 from the left and right sides. Therefore, workability during the attachment of electrical components 64 is high. In a case in which the electric components 64 are mounted using an automatic machine, fingers of the automatic machine do not interfere with the base member 10 if the electric components 64 are held so as to be pinched from the left and right sides using the fingers of the automatic machine.

Next, the pair of side-wall members 11 are attached to the base member 10. When assembling, the front insertion portions 15 are fitted into the front fitting portions 13 by inserting them from above, and the rear insertion portions 16 are fitted into the rear fitting portions 14 by inserting them from above. Specifically, the front insertion portions 15 are fitted into the groove portions 35, and the rear insertion portions 16 are fitted into the guide grooves 30. Even if the front insertion portions 15 are displaced in the left-right direction with respect to the front fitting portions 13, the displacements of the front insertion portions 15 are corrected by the guiding portions 36.

When the side-wall members 11 are brought into a predetermined attached state with respect to the base member 10, the stoppers 47 abut against the upper ends of the front fitting portions 13, and the rear insertion portions 16 abut against the reinforcing portions 29. At the same time, the fitting protrusions 46 are fitted into the fitting recess portions 37, and the locking protrusions 48 are locked to the locking holes 28. As a result of the front insertion portions 15 being fitted to the front fitting portions 13, the side-wall members 11 are positioned in the front-rear direction and the left-right direction with respect to the base member 10. As a result of the interlocking of the locking protrusions 48 and the locking holes 28, the side-wall members 11 are restricted from becoming detached upwardly with respect to the base member 10.

By attaching the side-wall members 11 to the base member 10, the component housing chamber 12 is covered from both the left and right sides by the side-wall members 11, and the assembly of the electrical junction box A is complete. The component housing chamber 12 is surrounded over the entire circumference thereof, from the front-rear and left-right directions.

In the state in which the side wall members 11 are attached to the base member 10, the connection plate portion 54 of each busbar 43 is placed on the upper surface of the plate-shaped mounting portion 40 of a plate 19. That is to say, the direction in which the side-wall members 11 are attached to the base member 10 and the direction in which the connection plate portions 54 are attached to the plate-shaped mounting portions 40 are the same. In a state where the connection plate portions 54 are placed on the plate-shaped mounting portions 40, bolts 70 are passed through the through-holes 56, the mounting holes 68, and the bolt holes 33. By screwing and fastening the bolts 70 into nuts 71 provided on the lower surfaces of the receiving plate portions 32, the plates 19 and the busbars 43 are fixed to the terminal block 18. By fixing the connection plate portions 54 to the receiving plate portions 32, the front ends of the side-wall members 11 are fixed to the front end of the base member 10.

### Operation and Effect of Embodiment

The electrical junction box A according to the present embodiment includes a base member 10 having a component housing chamber 12 whose lateral surfaces are open, and side-wall members 11 that are separate components from the base member 10. The side-wall members 11 are attached to the base member 10 so as to cover the lateral surfaces of the component housing chamber 12. Front insertion portions 15 and rear insertion portions 16 are formed in the side-wall members 11. Front fitting portions 13 and left and right rear fitting portions 14 are formed in the base member 10. In the process of attaching the side-wall members 11 to the base member 10, the front fitting portions 13 and the front insertion portions 15 slide and fit to each other, while the left and right rear fitting portions 14 and the rear insertion portions 16 slide and fit to each other. As the side-wall members 11 slide and fit to the base member 10, the base member 10 can hold the side-wall members 11 in a stably attached state.

The front fitting portions 13 have groove portions 35 that allow the front insertion portions 15 to slide in the state of being housed therein. As the base member 10 is provided with guiding portions 36 that guide the front insertion portions 15 to the groove portions 35 in the front fitting portions 13, workability is high during the attachment of the side-wall members 11 to the base member 10. The front fitting portions 13 are provided with windows 38 that connect the groove portions 35 to areas outside of and below the front fitting portions 13 via the fitting recess portions 37. The windows 38 are provided at distal ends of the groove portions 35 in the fitting direction of the front insertion portions 15, i.e., at the lower ends of the front fitting portions 13. With this configuration, the operator can visually check the fitting state of the front insertion portions 15 in the groove portions 35, that is, whether or not the fitting protrusions 46 of the front insertion portions 15 have reached the fitting recess portions 37 at the distal ends of the groove portions 35, by looking into the windows 38 from below the front fitting portions 13.

The base member 10 has plates 19 in which plate-shaped mounting portions 40 are formed. The side-wall members 11 have a busbar 43 in which connection plate portions 54 are formed. The connection plate portions 54 overlap the plate-shaped mounting portions 40 in the same direction as the direction in which the side-wall members 11 are attached to the base member 10. With this configuration, it is possible to connect the plate-shaped mounting portions 40 and the connection plate portions 54 to each other by attaching the side-wall members 11 to the base member 10. The connection plate portions 54 are located near the front insertion portions 15 in the left-right direction. With this configuration, it is possible to accurately attach the connection plate portions 54 to the plate-shaped mounting portions 40 by fitting the front insertion portions 15 into the front fitting portions 13.

The front fitting portions 13 and the plate-shaped mounting portions 40 of the plates 19 are located at the front end of the base member 10. The plate-shaped mounting portions 40 and the connection plate portions 54 of the busbar 43 are fixed by bolts 70 and nuts 71, which are fastening members. Elastic locking portions 26 that hold the side-wall members 11 in an attached state by elastically locking with the side-wall members 11 are formed at the rear end of the base member 10. With this configuration, the side-wall members 11 are each held by the base member 10 at two positions on the front and rear ends of the base member 10, and therefore the attached state of the base member 10 and the side-wall members 11 is stable. Fastening work with the bolts 70 and the nuts 71 need only be performed at the front end of the base member 10, and therefore workability is higher than when fastening work with the fastening members is performed at both front and rear ends.

Front fitting portions 13 having groove portions 35 and fitting recess portions 37 are formed at front end of the base member 10. As a result of the front insertion portions 15 and the fitting protrusions 46 fitting to each other, the groove portions 35 and the fitting recess portions 37 function as separation restricting portions that restrict the side-wall members 11 from moving laterally separated from the base member 10. Left and right rear fitting portions 14 having plate-shaped restricting portions 27 are formed at the rear end of the base member 10. By allowing the rear insertion portions 16 to abut against the plate-shaped restricting portions 27, the plate-shaped restricting portions 27 function as separation restricting portions that restrict the side-wall members 11 from moving laterally away from the base member 10. Overhanging portions 23 having hook portions 24 are formed in a lower end portion of the base member 10. By locking with the inner wall portions 45 of the side-wall members 11, the hook portions 24 function as separation restricting portions that restrict the side-wall members 11 from moving laterally away from the base member 10. The side-wall members 11 are restricted by the separation restricting portions (the hook portions 24 and the plate-shaped restricting portions 27) from moving away from the base member 10, and therefore the base member 10 and the side-wall members 11 can be held in a stably attached state.

As shown in FIGS. 1, 2, 5, and 11, the outer lateral surfaces of the side-wall members 11 are provided with recessed regions 66 with which the outer lateral surfaces are partially recessed in the width direction. The recessed regions 66 are regions located at lower positions than the enlarged-width portions 57 in the lateral surfaces of the side-wall members 11. The recessed regions 66 include the front insertion portions 15 and the rear insertion portions 16. The front fitting portions 13 and the left and right rear fitting portions 14 serving as separation restricting portions abut against the recessed regions 66. With this configuration, although the front fitting portions 13 and the left and right rear fitting portions 14 are provided so as to overlap the outer lateral surfaces of the side-wall members 11, an increase in the width dimension of the side-wall members 11 due to the presence of the front fitting portions 13 and the left and right rear fitting portions 14 can be suppressed.

Regions of the outer lateral surfaces of the side-wall members 11 where the enlarged-width portions 57 are formed are defined as outermost regions 67 of the outer lateral surfaces of the side-wall members 11, which are located outermost in the left-right direction. The front fitting portions 13 and the left and right rear fitting portions 14 are only located inward of the outermost regions 67. With this configuration, although the front fitting portions 13 and the left and right rear fitting portions 14 are provided so as to overlap the outer lateral surfaces of the side-wall members 11, the width dimension of the side-wall members 11 is not increased.

The base member 10 has elastic locking portions 26 that hold the side-wall members 11 in an attached state by elastically locking with the locking protrusions 48 of the side-wall members 11. The plate-shaped restricting portions 27 are continuous with side edges of the elastic locking portions 26. The side-wall members 11 are restricted by the plate-shaped restricting portions 27 from moving away from the base member 10, and therefore the locking protrusions 48 can be prevented from becoming detached from the elastic locking portions 26. As the plate-shaped restricting portions 27 protrude from the side edges of the elastic locking portions 26 at right angles, the flexural rigidity of elastic locking portions 26 is enhanced by the plate-shaped restricting portions 27. Thus, the reliability of the locking function of the elastic locking portions 26 and the locking protrusions 48 is improved.

The side-wall members 11 have busbar housing chambers 49 in which the busbars 43 are housed. Each busbar housing chamber 49 is partitioned by the outer wall portion 44 constituting an outer lateral surface of a side-wall member 11, and an inner wall portion 45 located between the outer wall portion 44 and the base member 10. The overhanging portions 23 have hook portions 24 that are hooked to the inner wall portions 45 from the outside. The hook portions 24 are hooked to the inner wall portions 45 rather than the outer wall portions 44, and therefore the hook portions 24 do not protrude greatly outward from the side walls. Therefore, it is possible to avoid increasing the dimension of the side-wall members 11 in the width direction.

The overhanging portions 23 are located so as to restrict the busbars 43 from becoming detached from the busbar housing chambers 49. The overhanging portions 23 have the function of restricting the side-wall members 11 from moving away from the base member 10 as well as the function of restricting the busbar 43 from becoming detached. Compared to forming dedicated portions separately from the overhang portions 23 to restrict the busbars 43 from becoming detached, the shape of the base member 10 can be simplified.

The side-wall members 11 have busbar mounting ports 50 that connect the busbar housing chambers 49 to the outside. The overhanging portions 23 are arranged so as to only cover portions, i.e., rear ends, of the busbar mounting ports 50. With this configuration, the heat generated by the busbars 43 can be effectively dissipated from the busbar mounting ports 50. Communication holes 25 that connect the busbar housing chambers 49 to the outside of the side-wall members 11 are formed in the overhanging portions 23. With this configuration, the heat generated by the busbars 43 can be dissipated to the outside of the side-wall members 11 through the communication holes 25.

### OTHER EMBODIMENTS

The present invention is not limited to the embodiment described based on the drawings and the description above, and, rather, is indicated by the claims. The present invention includes all modifications that are included in the claims and that are within the meaning and scope of equivalents of the claims, and is intended to also include the following embodiments.

In the above embodiment, the insertion portions are housed in the groove portions formed in the fitting portions. However, the insertion portions may be fitted into the fitting portions so as to be exposed to the outside of the fitting portions.

In the above embodiment, windows are formed in the fitting portions. However, the fitting portions may have a shape without a window.

In the above embodiment, the windows are formed at distal ends of the groove portions in the fitting direction. However, windows may be formed at closer positions than the distal ends of the groove portions.

In the above embodiment, the fitting portions are only located at the front end of the base member. However, the fitting portions may also be located at both the front and rear ends of the base member.

### LIST OF REFERENCE NUMERALS

A Electrical Junction Box
10 Base Member
11 Side-wall Member
12 Component Housing Chamber
13 Front Fitting Portion (Fitting Portion)
14 Rear Fitting Portion (Fitting Portion)
15 Front Insertion Portion (Insertion Portion)
16 Rear Insertion Portion (Insertion Portion)
17 Holding Member
18 Terminal Block
19 Plate (Connection Member)
20 Main Body Portion
21 Front Plate Portion
22 Rear Plate Portion
23 Overhanging Portion
24 Hook Portion
25 Communication Hole
26 Elastic Locking Portion
27 Plate-shaped Restricting Portion
28 Locking Hole
29 Reinforcing Portion
30 Guide Groove
31 Supporting Plate Portion
32 Receiving Plate Portion
33 Bolt Hole
34 Housing Space
35 Groove Portion
36 Guiding Portion
37 Fitting Recess Portion
38 Window
39 Plate-shaped Power Supply Portion
40 Plate-shaped Mounting Portion
41 Power Supply Connection Hole
42 Side-wall Main Body
43 Busbar
44 Outer Wall Portion
45 Inner Wall Portion
46 Fitting Protrusion
47 Stopper
48 Locking Protrusion
49 Busbar Housing Chamber
50 Busbar Mounting Port
51 Substrate Portion
52 Heat Dissipating Plate Portion
53 Tab
54 Connection Plate Portion
55 Supporting Portion
56 Through Hole
57 Enlarged-width Portion
58 Fuse Housing Chamber
59 Fuse
60 Lead
61 Cavity
62 Electric Wire
63 Harness Terminal
64 Electrical Component
66 Recessed Region
67 Outermost Region
68 Mounting Hole
70 Bolt (Fastening Member)
71 Nut (Fastening Member)

1. An electrical junction box comprising:
a base member having a component housing chamber with open lateral surfaces; and
side-wall members that are separate members from the base member and are attached to the base member so as to cover the lateral surfaces of the component housing chamber,
wherein the side-wall members are provided with insertion portions, and
the base member is provided with fitting portions into which the insertion portions are slid and inserted in a process of attaching the side-wall members to the base member.

2. The electrical junction box according to claim 1,
wherein the base member is provided with guiding portions that guide the insertion portions to the fitting portions.

3. The electrical junction box according to claim 1,
wherein the fitting portions respectively have groove portions that allow the insertion portions to slide in a state of being housed therein, and
the fitting portions are respectively provided with windows that connect the groove portions to an outside of the fitting portions.

4. The electrical junction box according to claim 3,
wherein the windows are respectively located at distal ends of the groove portions in a fitting direction of the insertion portions.

5. The electrical junction box according to claim 1,
wherein the base member has connection members respectively provided with plate-shaped mounting portions,
the side-wall members respectively have busbars provided with connection plate portions, and
the connection plate portions overlap the plate-shaped mounting portions in a same direction as a direction in which the side-wall members are attached to the base member.

6. The electrical junction box according to claim 5,
wherein the connection plate portions are located near the insertion portions.

7. The electrical junction box according to claim 5,
wherein the fitting portions and the plate-shaped mounting portions are located at a front end of the base member,
the plate-shaped mounting portions and the connection plate portions are fixed by fastening members, and
elastic locking portions that hold the side-wall members in an attached state by elastically locking with the side-wall members are provided at a rear end of the base member.
